(19) United States
(12) Patent Application Publication
(10) Pub. No.: US 2026/0252453 A1
(43) Pub. Date: Aug. 27, 2026

(54) DOCK AS A TELEMETRY DEVICE FOR NO POST NO VIDEO SYSTEM BEHAVIOR

(71) Applicant: DELL PRODUCTS L.P., Round Rock, TX (US)

(72) Inventors: Ibrahim Sayyed, Georgetown, TX (US); Venkata Rama Krishna Rao Atta, Hyderabad (IN); Marcin Nowak, Prosper, TX (US)

(21) Appl. No.: 19/063,060

(22) Filed: Feb. 25, 2025

(51) Int. Cl. G06F 11/30; G06F 13/42

(52) U.S. Cl. CPC G06F 11/3055; G06F 11/3089; G06F 13/4282

(57) ABSTRACT

An information handling system includes system on a chip (SoC) and an embedded controller. The SoC executes boot operations for the information handing system. In response to a boot failure during the SBIOS boot operations, the information handling system generates telemetry data associated with the boot failure. The embedded controller monitors the boot operations being executed by the SoC. In response to the boot failure, the information handling system enters into a service mode. During the service mode, the information handling system provides the telemetry data to a device connected to the information handling system.

### FIELD OF THE DISCLOSURE

The present disclosure generally relates to information handling systems, and more particularly relates to utilizing a dock to analyze no post no video system behaviors of an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes system on a chip (SoC) and an embedded controller. The SoC may execute boot operations for the information handing system. In response to a boot failure during the SBIOS boot operations, the information handling system may generate telemetry data associated with the boot failure. The embedded controller may monitor the boot operations being executed by the SoC. In response to the boot failure, the information handling system may enter into a service mode. During the service mode, the information handling system may provide the telemetry data to a device connected to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of a system including multiple information handling systems, a dock, a mobile device, and a remote server according to at least one embodiment of the present disclosure;

FIG. 2 is a flow diagram of a method for configuring a dock as a telemetry device to analyze no post no video system behaviors according to at least one embodiment of the present disclosure; and

The use of the same reference symbols in different drawings indicates similar or identical items.

### DETAILED DESCRIPTION OF THE DRAWINGS

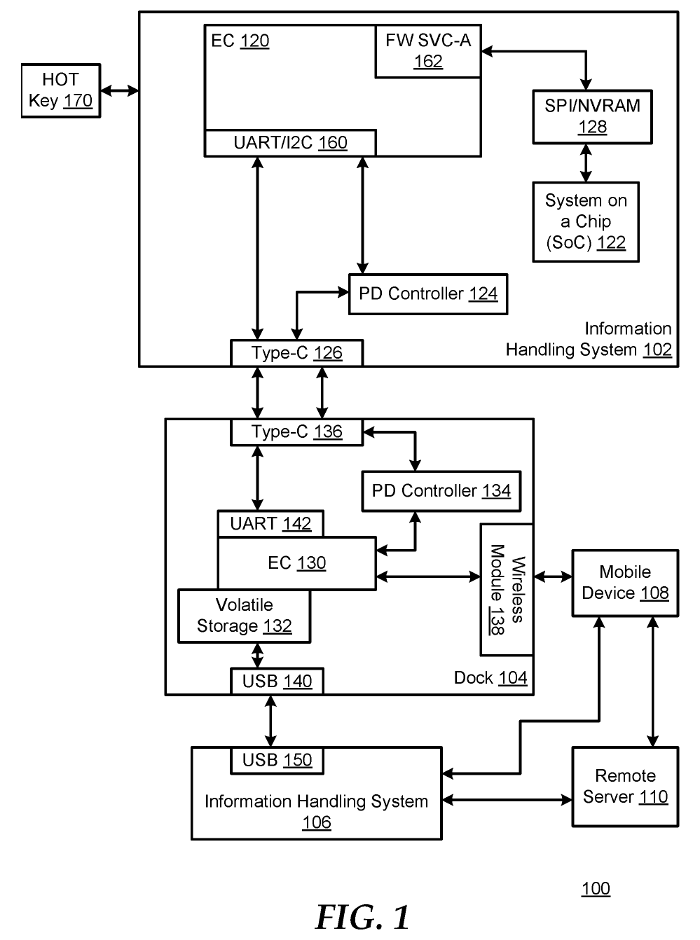

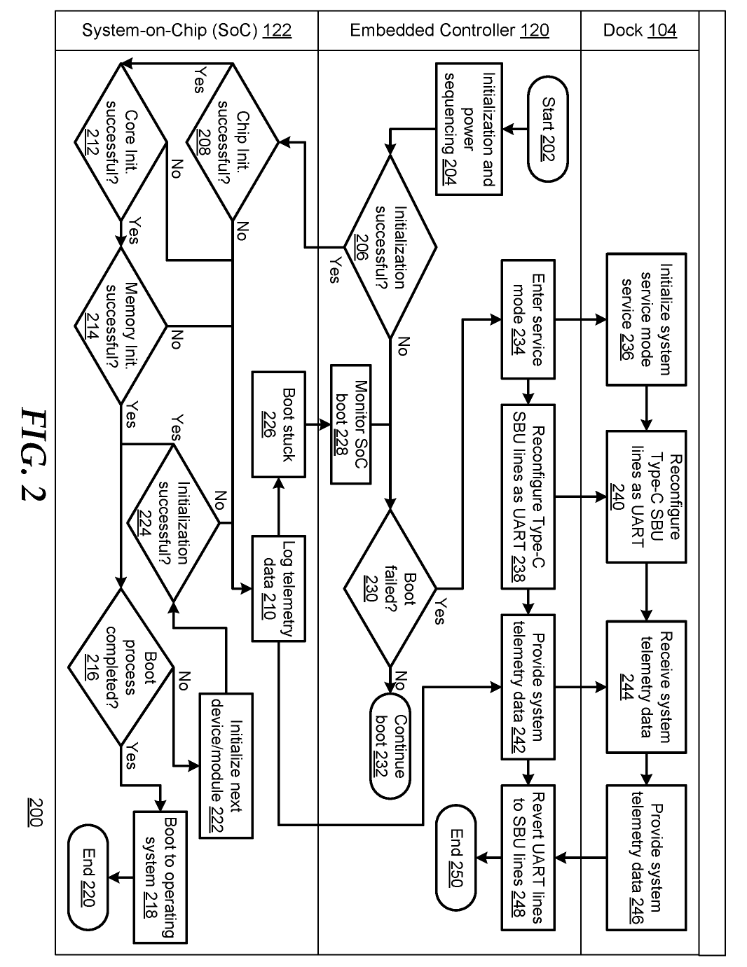

FIG. 1 illustrates a portion of a system 100 including an information handling system 102, a dock 104, another information handling system 106, a mobile device 108, and a remote server 110 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes an embedded controller 120, a system on a chip (SoC) 122, a power delivery (PD) controller 124, a universal serial bus (USB) type-C connector 126, and storage device 128. In an example, storage device 128 may be any suitable type of storage device, such as a serial peripheral interface/non-volatile random access memory (SPI/NVRAM) or the like. Dock 104 includes an embedded controller 130, a storage device 132, power delivery controller 134, a type-C connector 136, a wireless module 138, a USB connector 140, and universal asynchronous receiver-transmitter (UART) communication lanes 142. Information handling system 106 includes a USB connector 150 and other components such as the components of information handling system 300 in FIG. 3.

Embedded controller 120 includes UART/inter-integrated circuit (UART/I2C) communication lanes 160, and a firmware service (FW SVC-A) 162. In an example, firmware service 162 may be a driver to enable communication between embedded controller 120 and storage 128. Mobile device 108 may include any suitable components including, but not limited to, the components of information handling system 300 in FIG. 3. Remote server 110 may include any suitable components including, but not limited to, the components of information handling system 300 in FIG. 3. Information handling system 102 and dock 104 may include additional components without varying from the scope of this disclosure.

In an example, information handling system 102 may experience a no power situation during an attempt to power on the information handling system from long storage state. In this example, dock 104 may be utilized as the power source for information handling system 102. However, information handling system 102 may not show any “early sign of light (eSOL)” but dock 104 may be functioning. Information handling system 102 may be improved by embedded controller 120 providing telemetry data to dock 104 when a no post-no video (NP-NV) condition occurs during the boot operations of the information handling system.

During the boot operations of information handling system 102, embedded controller 120 may initiate the controlled system power sequencing. If the power sequence fails, embedded controller 120 may store the failure as telemetry data in storage 128. In an example, embedded controller 120 may provide this telemetry data to storage 128 via firmware service 162. In response to successful power sequence and root of trust (RoT), embedded controller 120 may pull out or wake SoC 122 from a reset state. Upon waking from the reset state, SoC 122 may start booting with system basic input/output system (SBIOS). In an example, the booting operations for SBIOS may follow the unified extensible firmware interface (UEFI) boot sequence, such as security (SEC) phase, pre-extensible firmware interface (EFI) initialization (PEI) phase, driver execution environment (DEX) phase, boot device selection (BDS) phase, and runtime (RT) phase. In certain examples, SoC 122 may include additional extensions to be performed on top of the UEFI boot operations.

Each phase of the SBIOS firmware boot operations may perform different activities, such as initializing chipset, initializing core, initializing platform, and initializing memory in PEI phase. During each phase, SoC 122 may log telemetry data into storage 128. In certain examples, the telemetry data may include any suitable data corresponding to the different activities or operations of the boot sequence. For example, the telemetry data may include, but is not limited to, all critical events, status, errors, and warnings.

In certain examples, embedded controller 120 may track the boot operations to determine whether a boot failure has occurred. In an example, the boot failure may be either due to failure in embedded controller power sequencing or a failure in the SoC boot process. In response to a detected boot failure, embedded controller 120 may perform a warm reset, such that information handling system 102 is restarted without fully shutting down before the restart. After the warm reset, embedded controller 120 may boot in special system service mode. While in the system service mode, embedded controller 120 may form a service mode session with dock 104. In an example, the service mode session may be formed based on dock 104 being attached to information handling system as a trusted Type-C device. Information handling system 102 and dock 104 may be connected via communication between PD controllers 124 and 134 and type-C connectors 126 and 136.

In an example, PD controllers 124 and 134 may utilize a side band communication, such as the configuration channel (CC) line of USB type-C connectors 126 and 136, between information handling system 102 and dock 104 to provide data between ECs 120 and 130. When information handling system 102 is in the system service mode, embedded controllers 120 and 130 may enter into a special session by exchanging vendor defined message (VDM) messages over CC lines between type-C connectors 126 and 136. In this special mode, embedded controllers 120 and 130 may negotiate and reconfigure the sideband use (SBU) lines in type-C connectors 126 and 128 as universal asynchronous receiver transmitter (UART) lines.

In an example, the reconfiguration of the SBU lines as UART lines may enable embedded controller 120 to communicate with embedded controller 130 without information handling system 102 being booted to the operating system (OS). For example, UART lines enable embedded controller 120 to communication in a simpler serial data format as compared to SBU lines of type-C communications. Additionally, embedded controllers 120 and 130 may ensure security by embedded controller 130 muting all external and internal interfaces during this special mode.

In response to embedded controllers 120 and 130 being in the system service mode, embedded controller 120 may generate its own telemetry data with system power sequencing and collect the telemetry data from storage 128. Upon collection of the telemetry data, embedded controller 120 may transfer the telemetry data to embedded controller 130 over UART lines of connectors 126 and 136 and UART lines 142 of embedded controller 130. After receiving the telemetry data, embedded controller 130 may store the data in storage 132 for later use.

In an example, embedded controller 130 may provide the telemetry data to remote server 110 via any suitable communication path. In certain examples, embedded controller 130 may send the telemetry data via an out of band (OOB) connectivity through wireless module 138, USB connector 140, or the like. The OOB connectivity of wireless module 138 may provide the telemetry data to remote server 110 via mobile device 108. In an example, an individual associated with information handling system 102 and dock 104 may utilize mobile device 108 to pull the telemetry data from the dock and provide the data to remote server 110. While embedded controller 130 may provide the telemetry data to remote server 110.

In certain examples, an individual associated with information handling system 102 and dock 104 may utilize information handling system 106 to pull the telemetry data from the dock and provide the data to remote server 110. In an example, information handling system 106 may utilize USB connector 150 and USB connector 140 of dock 104 to pull or receive the telemetry data from storage 132. The individual associated with information handling system 102 may then provide the telemetry data to remote server 110 via information handling system 106. In an example, an information technology (IT) administrator may utilize the telemetry data to perform an analysis of the system failure and take any accurate remediation. sends this data to Dell telemetry service using its OOB connectivity to dell cloud service.

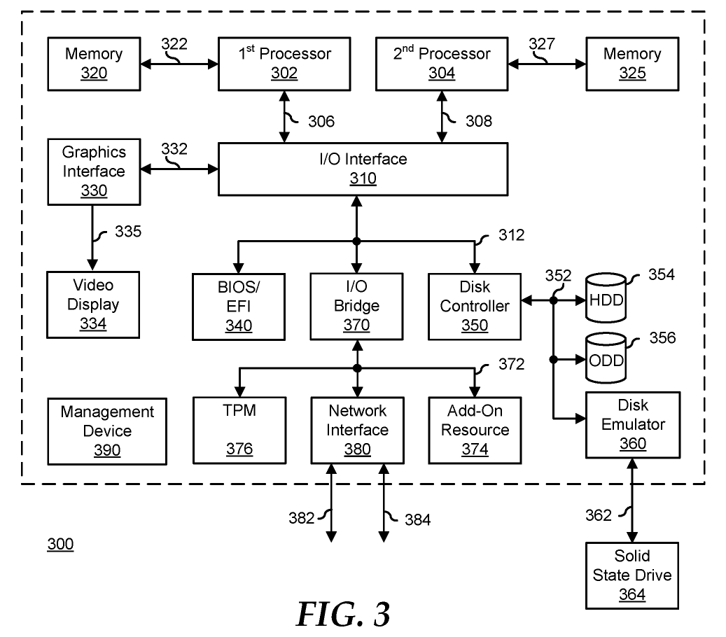

FIG. 2 shows a method 200 for configuring a dock as a telemetry device to analyze no post no video system behaviors according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 120 of information handling system 100 in FIG. 1, SoC 122 of information handling system 100 in FIG. 1, and dock 104 in FIG. 1, or any other type of controller, device, module, processor, or any combination thereof, operable to employ all, or portions of, the method of FIG. 2.

At block 204, initialization and power sequencing is begun. In an example, embedded controller 120 may perform the initialization and power sequencing as the initial start-up of SoC 122 in the information handling system. At block 206, a determination is made whether the initialization and power sequencing is successful. If not, the flow continues at block 230. If the initialization and power sequencing is successful, boot operations are performed in SoC 122 at blocks 208, 212, and 214. In an example, these SBIOS boot operations may be operations set in the UEFI boot sequence, such as SEC phase, PEI phase, DEX phase, BDS phase, and RT phase. Each phase of the SBIOS firmware boot operations may perform different activities, such as initializing chipset, initializing core, initializing platform, and initializing memory in PEI phase.

At block 208, a determination is made whether the chipset initialization is successful. If the chipset initialization is not successful, telemetry data associated with the chipset initialization failure is stored at block 210. In certain examples, the telemetry data is stored in a NVRAM storage device. If the chipset initialization is successful, a determination is made whether the core initialization is successful at block 212. If the core initialization is not successful, telemetry data associated with the core initialization failure is stored at block 210. If the core initialization is successful, a determination is made whether the memory initialization is successful at block 214.

If the memory initialization is not successful, telemetry data associated with the memory initialization failure is stored at block 210. If the memory initialization is successful, a determination is made whether the boot process is completed at block 216. If the boot process is completed, the information handling system boots to the operating system at block 218, and the flow ends at block 220. If the boot process is not completed, a next device/module is initialized at block 222. At block 224, a determination is made whether the initialization of the next device/module is successful. If the initialization is not successful, corresponding telemetry data is stored at block 210. If the initialization is successful, the flow continues at block 216.

In an example, when telemetry data associated with any failure is stored at block 210, a determination is made that the boot is stuck at block 226. At block 228, the SoC boot operations are monitored. In an example, embedded controller 120 may monitor the boot operations and at different intervals may provide indication of whether the boot is stuck. At block 230, a determination is made whether the boot has failed. In certain examples, this determination is made based on the indication provided in response to the monitoring of the SoC boot operations. If the SoC boot has not failed, the boot continues at block 232. If the SoC boot has failed, the embedded controller enters a service mode at block 234.

In an example, blocks 234 and 238 performed by embedded controller 120 may be performed in substantially parallel with corresponding blocks 236 and 240 performed by dock 104. At block 236, system service mode is initialized in dock 104. At blocks 238 and 240, USB type-C SBU lines are reconfigured as UART lines. In an example, the reconfigured UART lines may enable embedded controller 120 to communication in a simpler serial data format as compared to SBU lines of type-C communications.

At block 242, telemetry data is provided by embedded controller 120. In an example, the telemetry data is retrieved from the NRAM storage prior to the telemetry data being provided by the embedded controller. The telemetry data may be provided over the UART lines between embedded controller 120 and dock 104. At block 244, the telemetry data is received by dock 104. At block 246, the telemetry data is provided to a remote server. In certain examples, embedded controller 130 may send the telemetry data via an out of band (OOB) connectivity through wireless module 138, USB connector 140, or the like. The OOB connectivity of wireless module 138 may provide the telemetry data to remote server 110 via mobile device 108. In an example, an individual associated with information handling system 102 and dock 104 may utilize mobile device 108 to pull the telemetry data from the dock and provide the data to remote server 110. While embedded controller 130 may provide the telemetry data to remote server 110. At block 248, the UART lines are reverted back to SBU lines and the flow ends at block 250.

FIG. 3 shows a generalized embodiment of an information handling system 300 according to an embodiment of the present disclosure. Information handling system 300 may be substantially similar to information handling system 102 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356 , a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:a system on a chip (SoC) to:execute boot operations in the information handling system; andin response to a boot failure during the boot operations, generate telemetry data associated with the boot failure; andan embedded controller to communicate with the SoC, the embedded controller to:monitor the boot operations being executed by the SoC;in response to the boot failure, perform a warm reset of the information handling system, wherein the information handling system is restarted without fully shutting down during the warm reset;in response to the warm reset, bootthe information handling system into a service mode; andduring the service mode, provide, via a service mode session, the telemetry data to an external device connected to the information handling system.

2. The information handling system of claim 1, wherein prior to the execution of the boot operations, the embedded controller further to:execute an initialization and power sequencing for the information handling system; andin response to a failure of the initialization or the power sequencing, enter the information handling system into the service mode.

3. The information handling system of claim 1, wherein after the information handling system is in the service mode, the embedded controller further to: reconfigure sideband use (SBU) lines of a universal serial bus as universal asynchronous receiver transmitter (UART) lines.

4. The information handling system of claim 3, wherein the telemetry data is provided over the UART lines to the external device.

5. The information handling system of claim 4, wherein after the telemetry data is provided to the external device, the embedded controller further to: revert the UART lines to the SBU lines of the universal serial bus.

6. The information handling system of claim 1, further comprising:a storage device configured to store the telemetry data, wherein in response to the boot failure, the SoC further to: store the telemetry data in the storage device.

7. The information handling system of claim 6, wherein during the service mode, the embedded controller further to: retrieve the telemetry data from the storage device.

8. The information handling system of claim 1, in response the telemetry data being generated, the SoC to exit the boot operations.

9. A method comprising:executing, by a system on a chip (SoC) of an information handling system, boot operations in the information handling system;in response to a boot failure during the boot operations, generating, by the SoC, telemetry data associated with the boot failure;monitoring, by an embedded controller of the information handling system, the boot operations being executed by the SoC;in response to the boot failure, performing a warm reset of the information handling system, wherein the information handling system is restarted without fully shutting down during the warm reset;in response to the warm reset, bootingthe information handling system into a service mode; andduring the service mode, providing, by the embedded controller during a service mode session with an external device, the telemetry data to the external device connected to the information handling system.

10. The method of claim 9, wherein prior to the executing of the boot operations, the method further comprises:
executing an initialization and power sequencing for the information handling system;and in response to a failure of the initialization or the power sequencing, entering the information handling system into the service mode.

11. The method of claim 9, wherein after the information handling system is in the service mode, the method further comprising: reconfiguring sideband use (SBU) lines of a universal serial bus as universal asynchronous receiver transmitter (UART) lines.

12. The method of claim 11, wherein the telemetry data is provided over the UART lines to the external device.

13. The method of claim 12, wherein after the telemetry data is provided to the external device, the method further comprises: reverting the UART lines to the SBU lines of the universal serial bus.

14. The method of claim 9, in response to the boot failure, the method further comprises: storing the telemetry data in a storage device of the information handling system.

15. The method of claim 14, wherein during the service mode, the method further comprising: retrieving the telemetry data from the storage device.

16. The method of claim 9, wherein in response the telemetry data being generated, the SoC to exit the boot operations.

17. A system comprising:an information handling system including:a system on a chip (SoC) to:execute boot operations in the information handling system; andin response to a boot failure during the boot operations, generate telemetry data associated with the boot failure; and an embedded controller to communicate with the SoC, the embedded controller to:
monitor the boot operations being executed by the SoC;
in response to the boot failure, perform a warm reset of the information handling system, wherein the information handling system is restarted without fully shutting down during the warm reset;in response to the warm reset, bootthe information handling system into a service mode; andduring the service mode, provide, via a service mode session, the telemetry data; and
an external device to:receive, during the service mode session, the telemetry data from the information handling system; andstore the telemetry data.

18. The system of claim 17, wherein prior to the execution of the boot operations, the embedded controller further to:execute an initialization and power sequencing for the information handling system; andin response to a failure of the initialization or the power sequencing, enter the information handling system into the service mode.

19. The system of claim 17, wherein after the information handling system is in the service mode, the embedded controller further to: reconfigure sideband use (SBU) lines of a universal serial bus as universal asynchronous receiver transmitter (UART) lines.

20. The system of claim 19, wherein the telemetry data is provided over the UART lines to the external device.
